(19) United States
(12) Patent Application Publication
(10) Pub. No.: US 2015/0322242 A1
(43) Pub. Date: Nov. 12, 2015

(54) NANOCOMPOSITE RESIN COMPOSITION

(71) Applicant: FUJI ELECTRIC CO., LTD., Kawasaki-shi (JP)

(72) Inventors: Takayuki HIROSE, Sagamihara-city (JP); Miyako HITOMI, Zushi-city (JP)

(73) Assignee: FUJI ELECTRIC CO., LTD., Kawasaki-shi (JP)

(21) Appl. No.: 14/275,237

(22) Filed: May 12, 2014

(51) Int. Cl. C08K 9/02; C08K 9/10

(52) U.S. Cl. CPC C08K 9/02; C08K 9/10

(57) ABSTRACT

A nanocomposite resin composition having improved heat resistance, higher glass transition temperature, and excellent mechanical characteristics and thermal conductivity and cured nanocomposite resin material are disclosed. The resin composition comprises a thermosetting resin and/or a thermoplastic resin, a silane coupling agent, and an inorganic filler. The inorganic filler includes an inorganic filler with a particle diameter or long diameter of 1 nm to 99 nm and an inorganic filler with a particle diameter or long diameter of 100 nm to 100 μm. At least one of these inorganic fillers is formed of SiO₂-coated inorganic particles in which a coat of SiO₂ is formed on the surface of inorganic particles of AlN, a metal oxide selected from the group consisting of Al₂O₃, MgO and TiO₂, or a mixture of these.

### BACKGROUND OF THE INVENTION

A. Field of the Invention

The present invention relates to a nanocomposite resin composition for obtaining a cured insulating seal resin material for use in semiconductor module elements.

B. Description of the Related Art

In recent years, IGBTs (Insulated Gate Bipolar Transistors), MOSFETs (metal oxide semiconductor field effect transistors) and other power modules capable of operating in high-capacity, high-voltage environments have been widely used in consumer appliances and industrial equipment. In some of these various modules that use semiconductor elements (hereunder called “semiconductor modules”), the heat generated by the mounted semiconductor element can reach high temperatures. Reasons for this include the large amount of electricity used by the semiconductor element, the high degree of integration of the circuits in the semiconductor element, and the high operating frequency of the circuits. In this case, the glass transition temperature (Tg) of the insulating seal resin in the semiconductor module must be equal to or greater than the exothermic temperature.

An effective way of raising the Tg is to inhibit molecular movement of the resin. One way of doing this is to mix in an inorganic filler with a particle diameter of 1 to 99 nm (see for example Patent Documents 1 and 2). Moreover, silane coupling agents are generally used to strengthen the bonds between the inorganic filler and the resin (see for example Non-patent Document 1 and Patent Document 3).

In addition to high heat resistance, insulating seal resins for semiconductor modules need to combine a variety of physical properties, and must fulfill a number of requirements for mechanical properties (bending elasticity, linear expansion coefficient), adhesiveness, low hygroscopicity (low hydration) and the like for example. Thermal conductivity is also an important property for some applications.

With respect to mechanical properties and thermal conductivity in particular among these properties, efforts have been made to improve and control these properties by mixing a second inorganic filler of Al₂O₃ (alumina) or MgO (magnesia) with a particle diameter of 0.1 to 100 μm in the resin in addition to a first inorganic filler with a particle diameter of 1 to 99 nm to obtain a nanocomposite resin. FIG. 4 shows a schematic view of such a nanocomposite resin of prior art. Nanocomposite resin 11 of prior art is composed of first inorganic filler 13 with a particle diameter of 1 to 99 nm, second inorganic filler 12 with a particle diameter of 0.1 to 100 μm, and resin 14. A silane coupling agent is also normally used to improve the adhesiveness between first inorganic filler 13, second inorganic filler 12 and resin 14.

The effects of silane coupling agents are more difficult to achieve using Al₂O₃ and MgO as inorganic fillers than with an SiO₂ (silica) filler. That is, it has been found that separation is more likely at the interface between the resin and the Al₂O₃ or MgO inorganic filler. As a result, the problem has been that the desired mechanical properties and thermal conductivity are either not obtained, or are difficult to control. Moreover, because of the weak adhesiveness at the interface between the inorganic filler and the resin, the inorganic filler and resin may adhere tightly after the nanocomposite is manufactured but then undergo separation at the interfaces during long-term use, resulting in property fluctuation and deterioration, cracks and the like, and creating problems of long-term reliability. The same problems that occur using Al₂O₃ and MgO also occur when using TiO₂ (titania) or an aluminum nitride such as AlN (aluminum nitride) and other metal nitrides as an inorganic filler.
Patent Document 1: Japanese Patent Application Publication No. 2009-292866.
Patent Document 2: Japanese Patent Application Publication No. 2009-013227.
Patent Document 3: Japanese Patent Application Publication No. H11-35801.
Non-patent Document 1: Silane Coupling Agents (Dow Corning Toray Co., Ltd. Catalog, October, 2008).

### SUMMARY OF THE INVENTION

The present invention improves the adhesiveness between a resin and an inorganic filler (Al₂O₃, MgO, TiO₂ or other metal oxide or AlN or other metal nitride), making it possible to improve and control the mechanical properties and thermal conductivity, and to ensure long-term reliability.

One embodiment of the present invention is a nanocomposite resin composition comprising a resin formed of a thermosetting resin, a thermoplastic resin or a combination of these, a silane coupling agent, and an inorganic filler, wherein the inorganic filler includes an inorganic filler with a particle diameter or long diameter of 1 nm to 99 nm and an inorganic filler with a particle diameter or long diameter of 100 nm to 100 μm, and at least one of the inorganic filler with a particle diameter or long diameter of 1 nm to 99 nm and the inorganic filler with a particle diameter or long diameter of 100 nm to 100 μm is formed of SiO₂-coated inorganic particles in which a coat of SiO₂ is formed on the surface of inorganic particles of AlN, a metal oxide selected from the group consisting of Al₂O₃, MgO and TiO₂, or a mixture of these.

The particle diameter here is the diameter of each individual inorganic particle, and corresponds to the diameter of each particle assuming that the particle is perfectly spherical. An inorganic filler with a particle diameter of 1 to 99 nm is a group of inorganic filler particles with a maximum particle diameter of 99 nm or less and a minimum particle diameter of 1 nm or more, with the maximum particle diameter and minimum particle diameter being values obtained by measurement under an electron microscope. Similarly, an inorganic filler with a particle diameter of 100 nm to 100 μm is a group of inorganic filler particles with a maximum particle diameter of 100 μm or less and a minimum particle diameter of 100 nm to 100 μm. On the other hand, the long diameter of the filler is the length of the particle in the longitudinal direction in the case of a long, thin needle-shaped particle for example, and is a value obtained by measurement under an electron microscope.

In a nanocomposite resin composition, the inorganic filler preferably includes an inorganic filler with a particle diameter or long diameter of 1 nm to 99 nm and an inorganic filler with particle diameter or long diameter of 100 nm to 100 μm, wherein the inorganic filler with a particle diameter or long diameter of 1 nm to 99 nm contains inorganic particles of SiO₂, and the inorganic filler with particle diameter or long diameter of 100 nm to 100 μm contains the aforementioned SiO2-coated inorganic particles.

In the nanocomposite resin composition, the inorganic filler preferably includes an inorganic filler with a particle diameter or long diameter of 1 nm to 99 nm and an inorganic filler with particle diameter or long diameter of 100 nm to 100 μm, wherein both the inorganic filler with a particle diameter or long diameter of 1 nm to 99 nm and the inorganic filler with a particle diameter or long diameter of 100 nm to 100 μm are formed of the aforementioned SiO₂-coated inorganic particles.

In the nanocomposite resin composition, the inorganic filler preferably includes an inorganic filler with a particle diameter or long diameter of 1 nm to 99 nm and an inorganic filler with particle diameter or long diameter of 100 nm to 100 μm, wherein the inorganic filler with a particle diameter or long diameter of 1 nm to 99 nm contains the aforementioned SiO₂-coated inorganic particles, and the inorganic filler with particle diameter or long diameter of 100 nm to 100 μm contains inorganic particles of SiO₂.

The aforementioned coat of SiO₂ preferably has a thickness of 5 to 20 nm.

The SiO₂-coated inorganic particles are preferably prepared by a water glass method.

The SiO₂-coated inorganic particles are preferably prepared by surface fusion treatment.

The SiO₂-coated inorganic particles are preferably prepared by laser ablation.

The thermosetting resin is preferably an epoxy resin.

Another aspect of the present invention is a cured nanocomposite resin material, which is a cured resin material obtained by curing the nanocomposite resin composition according to any of the above.

A cured resin material obtained by curing the nanocomposite resin composition of the present invention has both improved adhesiveness between the first inorganic filler and the resin and improved adhesiveness between the second inorganic filler and the resin, making it possible to both improve the mechanical properties and thermal conductivity and control these properties. Such a cured resin material obtained by cured a nanocomposite resin composition can provide long-term reliability as an insulating material.

### BRIEF DESCRIPTION OF THE DRAWINGS

The foregoing advantages and features of the invention will become apparent upon reference to the following detailed description and the accompanying drawings, of which:

FIG. 1 is a schematic view of a nanocomposite resin of the invention.

FIG. 2 is a schematic view of a second inorganic filler in which a coat of SiO₂ is formed on the surface of metal oxide particles in the nanocomposite resin of the invention.

FIG. 3 is a graph showing the results of heat cycle testing of the nanocomposite resins of Examples 1 and 2 and the Comparative Example.

FIG. 4 is a schematic view showing the conditions of nanocomposite resins of prior art and the Comparative Example.

### DETAILED DESCRIPTION OF SPECIFIC EMBODIMENTS

Embodiments of the invention are explained below. However, the invention is in no way limited by the embodiments explained below.

### First Embodiment

The first embodiment of the present invention is a nanocomposite resin composition containing a thermosetting resin or thermoplastic resin, a silane coupling agent, a first inorganic filler and a second inorganic filler, wherein the second inorganic filler is formed of SiO₂-coated inorganic particles in which a coat of SiO₂ is formed on the surface of a metal nitride such as AlN (aluminum nitride) or a metal oxide selected from the group consisting of Al₂O₃ (alumina), MgO (magnesia) and TiO₂ (titania).

In all of the following embodiments of the present invention, the first inorganic filler refers to inorganic particles with a particle diameter or long diameter of 1 to 99 nm regardless of the type of compound making up the filler. Similarly, the second inorganic filler refers to inorganic particles with a particle diameter or long diameter of 100 nm to 100 μm regardless of the type of compound making up the filler. The particle diameter or long diameter of the particles here is the value before formation of the SiO₂ coat, and does not include the thickness of the SiO₂ coat.

The resin component of the nanocomposite resin composition may be either a thermosetting resin or a thermoplastic resin, or a mixture of a thermosetting resin and a thermoplastic resin.

A resin with a relatively high glass transition temperature [Tg] and a low dielectric constant of about 4 to 7 can be used as the thermosetting resin. Preferred examples of thermosetting resins include, but are not limited to, epoxy resins, polyimide resins, phenol resins, amino resins and unsaturated polyester resins. When the resin component is a thermosetting resin, the resin component contains a thermosetting base resin, a curing agent, and a cure accelerator as necessary. The cure accelerator can be used effectively to control the curing reaction.

The epoxy base resin as a preferred thermosetting resin is not particularly limited, but bisphenol A epoxy resin, bisphenol F epoxy resin and other bifunctional epoxy resins and phenol novolac epoxy resin, cresol novolac epoxy resin, bisphenol A novolac epoxy resin, bisphenol F novolac epoxy resin, naphthalene epoxy resin, biphenyl epoxy resin, dicyclopentadiene epoxy resin and other polyfunctional epoxy resins can be used individually, or a combination of more than one can be used.

The curing agent of the thermosetting resin can be selected to match the thermosetting base resin. For example, when using an epoxy base resin as the thermosetting base resin, a commonly-used epoxy resin curing agent can be used. In particular, amino curing agents, aliphatic polyamines, aromatic amines, acid anhydrides, phenol novolacs, phenol aralkyls and triphenolmethane phenol resins can be used as curing agents, but examples are not limited to these. Also, a molecule containing one or more of the functional groups —NH₃, —NH₂ and —NH in its molecular structure, or an acid anhydride, can be used favorably as the curing agent of an epoxy resin. Specific examples include diaminodiphenyl methane, diaminodiphenyl sulfone and other aromatic amines, aliphatic amines, imidazole derivatives, dicyandiamide, tetramethyl guanidine and other guanidine curing agents, thiourea addition amines, adipic dihydrazide, isophthalic dihydrazide, dodecanoic dihydrazide and other dihydrazide curing agents, 2-ethyl-4-methylimidazole and other imidazole curing agents, methyltetrahydrophthalic anhydride, tetrahydrophthalic anhydride, methylnadic anhydride, hexahydrophthalic anhydride, methylhexahydrophthalic anhydride and other acid anhydride curing agents, and isomers and modified forms of these. One of these may be used alone as the curing agent, or a mixture of two or more may be used.

2-Ethyl-4-methylimidazole and other imidazoles, benzyldimethylamine and other tertiary amines, triphenyl phosphine and other aromatic phosphines, boron trifluoride monoethylamine and other Lewis acids, and boric acid esters and the like may be used as cure accelerants, but examples are not limited to these.

The compounded proportion of the curing agent can be determined based on the amount of epoxy equivalents of the epoxy base resin and the amount of amine equivalents or acid anhydride equivalents of the curing agent. Similarly, when using a thermosetting base resin other than an epoxy base resin, the compounded proportion can be determined based on the reaction equivalents of each base resin and the reaction equivalents of the curing agent. When a cure accelerator is used, the compounded proportion of the cure accelerator is preferably 0.1 to 5 wt % given 100% as the weight of the epoxy base resin.

When the resin component is a thermoplastic resin, the thermoplastic resin may be a polyamide resin, polyethylene resin or polypropylene resin, but is not limited to these.

The silane coupling agent in the nanocomposite resin composition may be one having functional groups that react with the resin component, and alkoxy groups that bind to SiO₂. For example, when an epoxy resin is used for the resin component, the silane coupling agent preferably has amino groups, mercapto groups or epoxy groups, together with alkoxy groups. When a polyimide resin is used for the resin component, the silane coupling agent preferably has amino and alkoxy groups. The added amount of the silane coupling agent can be in the range of 0.01 to 30 wt % of the filler weight for example, but this is not a limitation.

In the first embodiment, the first inorganic filler is SiO₂ (silica) with a particle diameter or long diameter of 1 to 99 nm. The particle diameter or long diameter is preferably 5 to 30 nm, or more preferably 10 to 20 nm. The shape of the first inorganic filler is typically spherical, but this is not a limitation, and elliptical, needle and plate shapes are also possible. When the first inorganic filler is not spherical, the long diameter is preferably within the aforementioned size range. In this case, the particle diameter and long diameter are values obtained by measurement under an electron microscope as discussed above.

The first inorganic filler may also be SiO₂ (silica) with an average particle diameter or long diameter of 1 to 99 nm. The average particle diameter or long diameter of the first inorganic filler is preferably 5 to 30 nm, or more preferably 10 to 20 nm. In this Description, the average particle diameter of the filler is a value obtained by measurement using the BET method. The average long diameter is a value obtained by measurement using a laser diffraction particle size analyzer.

The first inorganic filler may be either porous (with a porosity of 70% or more, or 80% or more, or 85% or more, or 90% or more or 95% or more) or non-porous (with a porosity of less than 70%, or 60% or less, or 50% or less, or 40% or less, or 30% or less, or 20% or less).

The compounded proportion of the first inorganic filler in the nanocomposite resin composition of this embodiment is preferably 0.1 to 7 wt %. This compounded proportion (wt %) is represented as wt % given 100% as the weight of the entire nanocomposite resin composition before curing.

The second inorganic filler is formed of inorganic particles with a particle diameter or long diameter of 100 nm to 100 μm. The particle diameter or long diameter is preferably 10 to 100 μm, or more preferably 10 to 60 μm. The shape of the second inorganic filler is typically spherical, but this is not a limitation, and elliptical, needle and plate shapes are also possible. When the second inorganic filler is not spherical in shape, the long diameter (rather than the particle diameter) is preferably 100 nm to 100 μm. In this case, the particle diameter and long diameter are values measured by the methods described previously.

The second inorganic filler may also be formed of inorganic particles with an average particle diameter or long diameter of 100 nm to 100 μm. The average particle diameter or long diameter of the second inorganic filler is preferably 10 μm to 100 μm, or more preferably 10 to 60 μm.

In the first embodiment, the second inorganic filler is formed of inorganic particles in which a coat of SiO₂ is formed on the surface of a metal oxide or metal nitride. The metal oxide is preferably selected from Al₂O₃, MgO and TiO₂. These metal oxides contribute to increasing the glass transition temperature [Tg] of the resin, providing good electrical insulating properties (1011Ω·m or more) at room temperature, and improving the mechanical properties and thermal conductivity of the nanocomposite resin. The metal oxide may be one selected from Al₂O₃, MgO and TiO₂, or may be a mixture of two or more of these. AlN or the like for example may also be used as a metal nitride. Like the Al₂O₃, MgO and TiO₂ discussed above, AlN contributes to increasing the glass transition temperature of the resin, providing good electrical insulating properties (1011Ω·m or more) at room temperature, and improving or controlling the mechanical properties and thermal conductivity of the nanocomposite resin. A mixture of a metal oxide and a metal nitride may also be used.

“In which a coat of SiO₂ is formed on the surface of a metal oxide or metal nitride” signifies any state in which at least part of the metal oxide or metal nitride is covered with a coat of SiO₂, in such a way that it can be bound to a silane coupling agent. For example, the SiO₂ coat may be formed as dots. If the metal oxide or metal nitride is elliptical, needle-shaped or plate-shaped rather than spherical, it is sufficient to cover only the side with the largest surface area with a coat of SiO₂. Preferably half or more of the surface area of the metal oxide or metal nitride, and more preferably the entire surface of the metal oxide or metal nitride, is covered with a coat of SiO₂. More preferably, the entire surface of the metal oxide or metal nitride is covered with a uniform coat of SiO₂. Uniform here means that the difference between the maximum thickness and minimum thickness of the SiO₂ coat is about 4 nm or less.

The thickness of the SiO₂ coat depends on the particle diameter or long diameter of the second inorganic filler, but generally 5 to 20 nm is desirable. Below 5 nm, the coat may be less uniform and the effect on binding by the silane coupling agent may be less due to the structure of the SiO₂, while above 20 nm the effect of mixing the second inorganic filler may be diminished.

In this Description, such inorganic particles in which a coat of SiO₂ is formed on the surface of a metal oxide or metal nitride are called “SiO₂-coated inorganic particles”. A commercial material may be used for the SiO2-coated inorganic particles, or they may be prepared by the following methods.

Examples of methods of preparing SiO₂-coated inorganic particles include wet coat forming methods, particularly the water glass method. In the water glass method, water glass with a Na₂O.xSiO₂.nH₂O (x=2 to 4) composition is dissolved in water to prepare a water glass aqueous solution, and metal oxide particles or metal nitride particles are added to the water glass aqueous solution. Hydrochloric acid is then added to this solution to hydrolyze the water glass and cause a gel of silicic acid (H₂SiO₃) to adhere to the surfaces of the metal oxide particles or metal nitride particles. A thin (5 to 20 nm) SiO₂ coat can be formed by keeping the added amount of the water glass at 0.05 to 90 wt % (as SiO₂) of the metal oxide particles. This method of preparing SiO₂-coated inorganic particles by the water glass method is disclosed for example in Japanese Patent Application Publication No. 2009-158802. A more uniform coat can be obtained by this coat-forming method than by the surface fusion treatment described below, or by coat formation using dry coat-forming methods.

Another example of a method of preparing SiO₂-coated inorganic particles is by surface fusion treatment. A compression shear-type mechanical particle complexing device can be used in surface fusion treatment. A mixture of mother particles with a large particle diameter and daughter particles with a small particle diameter is loaded into the device, and compression and shear are applied repeatedly by mechanical means to fix (fuse) the daughter particles to the mother particles. In this embodiment, SiO₂-coated inorganic particles can be prepared by mixing 100 wt % of AlN (aluminum nitride) or other metal nitride particles or metal oxide particles of Al₂O₃, MgO or TiO₂ with an average particle diameter of 0.1 to 100 μm with 0.05 to 90 wt % of SiO₂ particles with an average particle diameter of 1 to 20 nm, and processing them in a mechanical particle complexing device. Because the original nano-sized SiO2 particles are manufactured at high temperatures, the particles themselves should be highly heat resistant in this coat-forming method. Thus, the resulting coat is expected to be more heat resistant than one obtained by a coat-forming process using the water glass method described above, so this method is advantageous for raising the heat resistance of the coat itself.

Other examples of methods of preparing SiO₂-coated inorganic particles include dry coat-forming methods. In dry coat-forming methods, a uniform coat can be formed uniformly on the surface of metal oxide particles or metal nitride particles. Examples include vapor deposition, sputtering and laser ablation, and any of these may be used, but laser ablation is especially desirable. In the laser ablation method, the metal oxide particles or metal nitride particles are placed in a specific container inside a chamber, the container is oscillated, and an ultraviolet laser is focused on an SiO₂ target inside the chamber. The SiO₂ target is evaporated by the laser and adheres uniformly to the particles inside the oscillating container, forming a SiO₂ coat with a thickness of 5 to 20 nm. This method of preparing SiO₂-coated inorganic particles by laser ablation is disclosed for example in Japanese Patent Application Publication No. 2009-164402. In this coat-forming method, it is easier to control the composition of the coat than in the coat-forming methods using water glass and surface fusion treatment described above because there is little variance in composition between the target and the coat. As a result, when introducing another added element or forming a coat with a mixed composition including an oxide other than SiO2 it is possible to use a target that matches the composition of the coat, making this more advantageous than other methods in such circumstances.

The second inorganic filler may be either porous (with a porosity of 70% or more, or 80% or more, or 85% or more, or 90% or more or 95% or more) or non-porous (with a porosity of less than 70%, or 60% or less, or 50% or less, or 40% or less, or 30% or less, or 20% or less). The porosity here is the porosity of the inorganic filler itself without the coat.

The compounded proportion of the second inorganic filler in the nanocomposite resin composition of this embodiment is preferably 70 to 85 wt %. The compounded proportion (wt %) is represented as wt % given 100% as the weight of the nanocomposite resin composition as a whole before curing.

The nanocomposite resin composition of this embodiment is formed of the aforementioned resin component, silane coupling agent, first inorganic filler and second inorganic filler, and need not contain any other components. However, conventionally known glass fiber, carbon fiber, graphite fiber, aramid fiber or other reinforcing fiber may also be included as another optional component. In addition, other additives may also be included within the scope of the present invention if they do not detract from the physical properties of the nanocomposite resin composition.

Another aspect of the present invention is a cured nanocomposite resin material obtained by curing a nanocomposite resin composition according to the first embodiment.

Next, the nanocomposite resin composition and cured material of the invention of the application are explained in terms of their manufacturing method. The method of manufacturing the nanocomposite resin composition and cured material comprises a first step of preparing a second inorganic filler, a second step of mixing and dispersing a thermosetting resin or thermoplastic resin, a first inorganic filler, the second inorganic filler and a silane coupling agent, a third step of mixing in a thermosetting resin curing agent and an optional cure accelerator, and a fourth step of heat curing the mixture obtained in the third step. The first step may be omitted when a commercial material is used as the second inorganic filler. Also, the third and fourth steps may be omitted when using a thermoplastic resin.

The first step can be performed as a step of forming a SiO₂ coat on a metal nitride such as AlN (aluminum nitride) or a metal oxide such as Al₂O₃, MgO or TiO₂ in accordance with the SiO₂-coated inorganic particle preparation method explained above with reference to the second inorganic filler.

In the second step, a thermosetting base resin, a first inorganic filler, the second inorganic filler and a silane coupling agent are mixed and dispersed together. Mixing is also performed at this stage when a thermoplastic resin is used instead of the thermosetting base resin. A commercial atomizing device, powder mixing apparatus or superfine particle complexer can be used for dispersal, and for example a NANOMIZER Inc. Nanomizer (high-pressure wet medialess atomizer) or a HOSOKAWA MICRON CORPORATION Nobilta or Nanocular or the like can be used, but these examples are not limiting. When using a Nanomizer, the treatment conditions may be 5 to 10 minutes of treatment repeated 2 to 5 times at a treatment pressure of 100 to 150 MPa. The treatment pressure and treatment time can be varied appropriately.

The third step is a step of adding a curing agent and an optional cure accelerator to the dispersed mixture. The curing agent and cure accelerator may also be mixed with the dispersed resin mixture by manual agitation in the third step.

The fourth step is a heat curing step in which the mixture with the added curing agent is heated and cured. The mixture here is cured in accordance with ordinary methods by heating it to a temperature at or above the curing temperature of the thermosetting resin. In the case of an epoxy resin for example, heating is preferably performed for about 1 to 20 hours at 100 to 250° C. When a thermoplastic resin is used as the resin component, it is not necessary to add a curing agent or to heat the resin.

When the nanocomposite resin composition is used in an insulating seal of a semiconductor module, the cured nanocomposite resin material is normally manufactured as a unit with the semiconductor module. Thus, another aspect of the present invention provides a method of manufacturing a semiconductor module. Specifically, the semiconductor module manufacturing method may comprise principally a step in which a semiconductor element assembly including a metal block, an insulating layer and a circuit element is set in a mold or case, and a step in which a nanocomposite resin composition of the first, second or third embodiment is heat cured inside the mold or case. When the method of manufacturing a cured nanocomposite resin material of the present invention is used to seal a semiconductor element, an effective seal can be obtained even if the heat generated by the semiconductor element reaches high temperatures, resulting in excellent breakdown characteristics.

### Second Embodiment

The second embodiment of the present invention is a nanocomposite resin composition comprising a resin component, a silane coupling agent, a first inorganic filler and a second inorganic filler, wherein both of the first inorganic filler and the second inorganic filler are formed of SiO₂-coated inorganic particles in which a coat of SiO₂ is formed on the surface of a metal nitride such as AlN (aluminum nitride) or a metal oxide selected from the group consisting of Al₂O₃, MgO and TiO₂.

In the nanocomposite resin composition of the second embodiment, the resin component, silane coupling agent and second inorganic filler are as explained with reference to the first embodiment, and may be configured similarly.

In the second embodiment, the first organic filler is formed of SiO2-coated inorganic particles in which a coat of SiO₂ is formed on the surface of a metal nitride such as AlN (aluminum nitride) or a metal oxide selected from Al₂O₃, MgO and TiO₂. Thus, apart from having a particle diameter or long diameter of 1 to 99 nm, the first inorganic filler of the second embodiment is similar to the second inorganic filler of the first embodiment in other respects.

The compounded proportions of the first inorganic filler and second inorganic filler in the resin composition of the second embodiment may also be similar to those of the first embodiment. Specifically, the proportion of the first inorganic filler can be 0.1 to 7 wt % and the proportion of the second inorganic filler can be 70 to 85 wt % given 100% as the weight of the entire nanocomposite resin composition before curing.

The nanocomposite resin composition of the second embodiment can also be cured to obtain a cured resin material.

The method of manufacturing the nanocomposite resin composition and cured material of the second embodiment is also generally similar to that explained for the first embodiment. In the method of manufacturing the composition of the second embodiment, SiO₂-coated inorganic particles are prepared as both the first inorganic filler and the second inorganic filler in the first step. These can be prepared by applying the water glass method, surface fusion treatment or laser ablation separately to two groups of metal oxide particles with different particle diameters. One or both of these may also be commercial products.

Because both the first inorganic filler and second inorganic filler of the nanocomposite resin composition and cured material of the second embodiment are SiO22-coated inorganic particles, thermal conductivity can be improved over that of the first embodiment by using AlN (aluminum nitride) or other metal nitride particles or metal oxide particles of Al₂O₃, MgO or TiO₂, which have greater thermal conductivity than SiO₂ particles. In particular, this is expected to be advantageous from the standpoint of uniform heat conduction because the first inorganic filler is finely dispersed in the resin and is formed of SiO₂-coated inorganic particles.

### Third Embodiment

The third embodiment of the present invention is a nanocomposite resin composition containing a resin component, a silane coupling agent, a first inorganic filler and a second inorganic filler, wherein the first inorganic filler is formed of SiO₂-coated inorganic particles in which a coat of SiO2 is formed on the surface of a metal nitride such as AlN (aluminum nitride) or a metal oxide selected from Al₂O₃, MgO and TiO₂, while the second inorganic filler is formed of SiO₂.

In the nanocomposite resin composition of the third embodiment, the resin component and silane coupling agent are as explained above with reference to first embodiment, and may be configured similarly. Moreover, the first organic filler is as explained above for the second embodiment, and may be configured similarly.

In the third embodiment, the second inorganic filler is formed of SiO₂. Thus, apart from having a particle diameter or long diameter of 100 nm to 100 μm, the second inorganic filler of the third embodiment is similar to the first inorganic filler of the first embodiment in other respects.

The compounded proportions of the first inorganic filler and second inorganic filler in the resin composition of the third embodiment may be 0.1 to 7 wt % of the first inorganic filler and 70 to 85 wt % of the second inorganic filler given 100% as the weight of the entire nanocomposite resin composition before curing.

The nanocomposite resin composition of the third embodiment can also be cured to obtain a cured resin material.

The method of manufacturing the nanocomposite resin composition and cured material of the third embodiment is also generally similar to that explained for the first embodiment. In the method of manufacturing the composition of the third embodiment, SiO₂-coated inorganic particles are prepared as the first inorganic filler in the first step.

Because the first inorganic filler is formed of SiO₂-coated inorganic particles while the second inorganic filler is formed of SiO₂ in the nanocomposite resin composition and cured material of the third embodiment, uniform thermal conductivity can be expected as in the second embodiment. Obtaining satisfactory thermal and mechanical properties while using SiO₂ particles for the second inorganic filler is an advantage because it eliminates the need for expensive Al₂O₃. The third embodiment is applicable to cases in which SiO₂ particles are used as the second organic filler in order to adjust the thermal and mechanical properties, either alone or mixed together with SiO₂-coated AlN (aluminum nitride) or other metal nitride particles or Al₂O₃, MgO or TiO₂ metal oxide particles.

The first, second and third embodiments may be adopted appropriately or combined with one another according to the necessary characteristics.

### EXAMPLES

The invention is explained in detail below using examples. The following examples do not limit the present invention.

### Example 1

The second inorganic filler was prepared first in Example 1. For the second inorganic filler, a SiO₂ coat was formed on the surface of the metal oxide Al₂O₃. Al₂O₃ with an average particle diameter of 30 μm as used, and the SiO₂ coat was formed with an average thickness of 10 nm. The thickness of the SiO₂ coat was measured with a transmission electron microscope.

Specifically, water glass with a Na₂O.xSiO₂.nH₂O (x=2 to 4) composition (Fuji Kagaku CORP.) was dissolved in water to prepare an aqueous solution. This water glass aqueous solution was alkaline. Next, Al₂O₃ particles were added to the water glass aqueous solution. Hydrochloric acid was then added to this solution, with the pH maintained at 6.5 to 8.5. The water glass was hydrolyzed, and a silica gel (H₂SiO₃) was made to adhere to the Al₂O₃ particles. This was then dried to form a coat of SiO₂. By adjusting the concentration of the aqueous water glass solution to 0.1 wt % (as SiO₂), it was possible to control the thickness of the SiO₂ coat at 10 nm. The second inorganic filler prepared in Example 1 had a coat of SiO₂ formed on the entire surface of the Al₂O₃ particles. FIG. 2 shows a schematic cross-sectional view of the second inorganic filler. In FIG. 2, the second inorganic filler appears with SiO₂ coat 22 formed on the entire surface of the metal oxide Al₂O₃ particle 21.

SiO₂ particles with an average particle diameter of 12 nm were prepared as the first inorganic filler. Bisphenol A epoxy resin (Material No. 828, Mitsubishi Chemical Corporation) was used as the epoxy base resin. The first inorganic filler and second inorganic filler were then mixed with the epoxy base resin so that the compounded proportion of the first inorganic filler was 3 wt % and the compounded proportion of the second inorganic filler was 85 wt % given 100% as the total weight of the nanocomposite resin composition. A silane coupling agent (Dow Corning Toray Co., Ltd. Z-6011) was also mixed in to 1 wt % of the weight of the filler.

This mixture was then agitated to disperse the first inorganic filler and second inorganic filler in the resin. Dispersion was performed with a NANOMIZER Inc. Nanomizer. Treatment was repeated three times, 6 minutes each time, at a treatment pressure of 130 MPa.

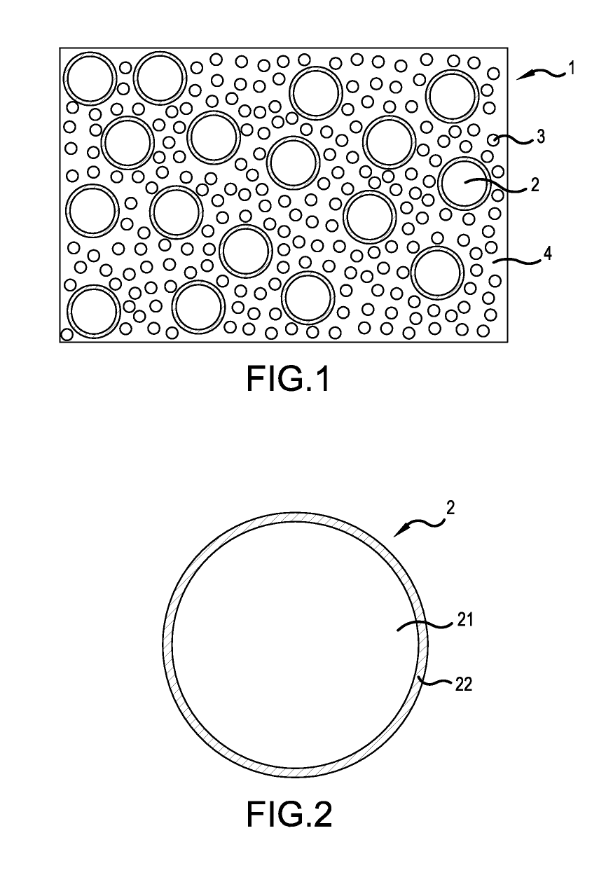

A curing agent and a cure accelerator were mixed in with the dispersed mixture, and agitated by hand. Modified alicyclic amine (Material No. 113, Mitsubishi Chemical Corporation) was used as the curing agent, and imidazole (EM124, Mitsubishi Chemical Corporation) as the cure accelerator. Curing treatment was performed following agitation. For the treatment conditions, the temperature was maintained at 80° C. for 1 hour and at 150° C. for 3 hours. FIG. 1 shows a schematic view of the cured nanocomposite resin material obtained in Example 1. In the heat-cured nanocomposite resin of the invention, first inorganic filler 3 of SiO₂ with an average particle diameter of 12 nm and second inorganic filler 2 in which an SiO₂ coat is formed on the surface of Al₂O₃ with an average particle diameter of 30 μm are dispersed in resin 4. The silane coupling agent (not shown) is also dispersed in the resin 4. The alkoxy groups of the silane coupling agent are converted by hydrolysis to hydroxyl groups, which then bind to the surfaces of the first inorganic filler 3 and second inorganic filler 2, while the organic functional groups bind to the epoxy groups of the epoxy resin 4.

### Example 2

A nanocomposite resin composition was prepared by a different method from Example 1 using a second inorganic filler in which an SiO₂ coat is formed on the surface of a metal oxide. That is, the composition was prepared as in Example 1 except for the method of preparing the second inorganic filler.

Al₂O₃ with an average particle diameter of 30 μm was used as the metal oxide here. Moreover, surface fusion treatment was used as the method of forming the surface SiO₂ coat. A compression shear-type mechanical particle complexing device was used as the equipment. A mixture of mother particles with a large particle diameter and smaller daughter particles is loaded into this device, and the daughter particles can be fixed (fused) to the mother particles by repeated mechanical application of compression and shear. In this example, SiO₂ particles with an average particle diameter of 12 nm were mixed at a rate of 2 wt % with Al₂O₃ particles with an average particle diameter of 30 μm and loaded into the device, and mechanical compression and shear were repeated continuously to thereby fix the SiO₂ particles to the surfaces of the Al₂O₃ particles, forming a coat. Al₂O₃ was used here as the metal oxide, but the same effects can be obtained using MgO or TiO₂ as the metal oxide, or when using AlN instead of a metal oxide.

### Comparative Example

In the Comparative Example, an Al₂O₃ filler with an average particle diameter of 30 μm was used in place of the second fillers used in Examples 1 and 2 above. Apart from this, the nanocomposite resin of the Comparative Example was obtained by similar methods and with a similar composition. FIG. 4 shows a schematic view of the cured nanocomposite resin material obtained in the Comparative Example. In the heat-cured nanocomposite resin material, first inorganic filler 13 of SiO₂ with an average particle diameter of 12 nm and second inorganic filler 12 of Al₂O₃ with an average particle diameter of 30 μm are dispersed in resin 14. A silane coupling agent (not shown) is also dispersed in resin 14, and the alkoxy groups of the silane coupling agent are converted by hydrolysis to hydroxyl groups, which bind to the surface of first inorganic filler 13, while the organic functional groups bind to the epoxy groups of the epoxy resin. However, second inorganic filler 12 does not bind with the silane coupling agent.

### Test Example

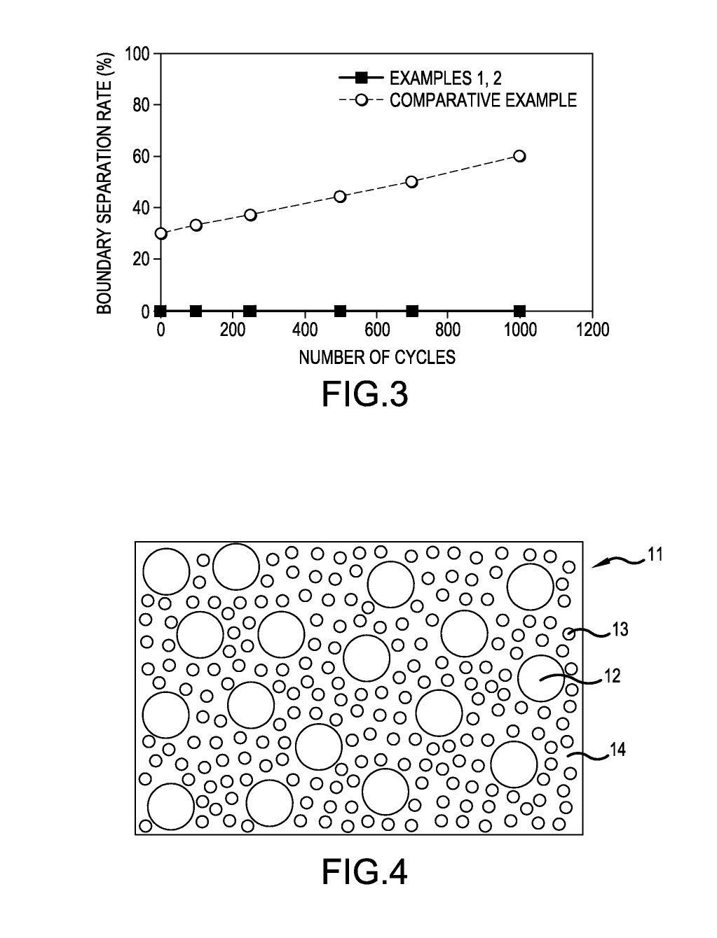

The cured nanocomposite resin materials of Examples 1 and 2 and the Comparative Example were subjected to heat cycle testing. This test was performed to confirm boundary separation after long-term use. 1000 cycles were performed with one cycle composed of 30 minutes at −40° C. (low temperature side) and 30 minutes at 150° C. (high temperature side). Samples were taken in the course of testing, and FIG. 3 shows a graph of the occurrence of boundary separation between the resin and the first and second inorganic fillers.

In Examples 1 and 2, no boundary separation occurred between the resin and the first and second inorganic fillers during 1000 cycles of testing. In the Comparative Example, boundary separation began even before testing, the rate of separation increased as the number of test cycles increased, and after 1000 cycles boundary separation between the resin and the second inorganic filler had occurred in about 60% of the samples. To obtain other examples, the particle diameter of the first inorganic filler was also changed to 7 nm and 30 nm, MgO was substituted for Al₂O₃ as the second inorganic filler, the particle diameter of the Al₂O₃ and MgO of the second inorganic filler was changed to 10 μm and 60 μm, SiO₂ coats were formed on each of the second inorganic fillers, and cured resin materials of the invention were manufactured. Although the results are not shown in detail, no boundary separation occurred in the 1000 cycle test in any of these cases.

The bending elastic moduli of the cured nanocomposite resin materials of Examples 1 and 2 and the Comparative Example were evaluated by the bend test method. The evaluation subjects were samples before heat cycle testing and samples after 1000 cycles. The bending elastic modulus of the samples before heat cycle testing was 15 GPa in Examples 1 and 2, but in the Comparative Example it was 13 GPa, a lower value than in Examples 1 and 2. The bending elastic modulus after 1000 cycles was unchanged in Examples 1 and 2. Even when the particle diameter of the first inorganic filler, the particle diameter of the second inorganic filler and the type of compound of the second inorganic filler were varied as described above, moreover, there was no change in the bending elastic modulus of the samples after 1000 cycles. In the sample of the Comparative Example, on the other hand, the bending elastic modulus fell to about 10 GPa from 13 GPa before heat cycle testing. This shows that boundary separation between the resin and the second inorganic filler affects the bending elastic modulus.

The occurrence of boundary separation due to heat cycle testing is an indication that the characteristics are likely to change during long-term use. Thus, a problem of long-term reliability is indicated in the case of the cured resin material of the Comparative Example. On the other hand, no boundary separation occurred during heat cycle testing of Examples 1 and 2. That is, there was no change in characteristics due to long-term use, and long-term reliability was obtained.

### INDUSTRIAL APPLICABILITY

The nanocomposite resin composition of the present invention can be used effectively in applications in which there is a danger of high exothermic temperatures, such as insulating seals for semiconductor modules and photovoltaic cells and other electrical parts and electrical products.

Thus, a nanocomposite resin composition has been described according to the present invention. Many modifications and variations may be made to the techniques and structures described and illustrated herein without departing from the spirit and scope of the invention. Accordingly, it should be understood that the compositions described herein are illustrative only and are not limiting upon the scope of the invention.

### EXPLANATION OF REFERENCE NUMERALS

1: Cured nanocomposite resin material
2: Second inorganic filler
3: First inorganic filler
4: Resin component
11: Conventional cured nanocomposite resin material
12: Second inorganic filler
13: First inorganic filler
14: Resin component
21: Metal oxide
22: Coat of SiO₂

What is claimed is:

1. A nanocomposite resin composition comprising:
a resin formed of a thermosetting resin, a thermoplastic resin or a combination of these;
a silane coupling agent; and
an inorganic filler,
wherein the inorganic filler includes an inorganic filler with a particle diameter or long diameter of 1 nm to 99 nm and an inorganic filler with a particle diameter or long diameter of 100 nm to 100 μm, and at least one of the inorganic filler with a particle diameter or long diameter of 1 nm to 99 nm and the inorganic filler with a particle diameter or long diameter of 100 nm to 100 μm is formed of SiO₂-coated inorganic particles in which a coat of SiO₂ is formed on the surface of inorganic particles of AlN, a metal oxide selected from the group consisting of Al₂O₃, MgO and TiO₂, or a mixture of these.

2. The nanocomposite resin composition according to claim 1, wherein the inorganic filler includes an inorganic filler with a particle diameter or long diameter of 1 nm to 99 nm and an inorganic filler with a particle diameter or long diameter of 100 nm to 100 μm, and the inorganic filler with a particle diameter or long diameter of 1 nm to 99 nm includes inorganic particles of SiO₂, and the inorganic filler with a particle diameter or long diameter of 100 nm to 100 μm includes the SiO₂-coated inorganic particles.

3. The nanocomposite resin composition according to claim 1, wherein the inorganic filler includes an inorganic filler with a particle diameter or long diameter of 1 nm to 99 nm and an inorganic filler with a particle diameter or long diameter of 100 nm to 100 μm, and both the inorganic filler with a particle diameter or long diameter of 1 nm to 99 nm and the inorganic filler with a particle diameter or long diameter of 100 nm to 100 μm are formed of the SiO₂-coated inorganic particles.

4. The nanocomposite resin composition according to claim 1, wherein the inorganic filler includes an inorganic filler with a particle diameter or long diameter of 1 nm to 99 nm and an inorganic filler with a particle diameter or long diameter of 100 nm to 100 μm, and the inorganic filler with a particle diameter or long diameter of 1 nm to 99 nm includes the SiO₂-coated inorganic particles, and the inorganic filler with a particle diameter or long diameter of 100 nm to 100 μm includes inorganic particles of SiO₂.

5. The nanocomposite resin composition according to claim 1, wherein the coat of SiO₂ has a thickness of 5 to 20 nm.

6. The nanocomposite resin composition according to claim 1, wherein the SiO₂-coated inorganic particles are prepared by a water glass method.

7. The nanocomposite resin composition according to claim 1, wherein the SiO₂-coated inorganic particles are prepared by surface fusion treatment.

8. The nanocomposite resin composition according to claim 1, wherein the SiO₂-coated inorganic particles are prepared by a laser ablation method.

9. The nanocomposite resin composition according to claim 1, wherein the thermosetting resin is an epoxy resin.

10. A cured nanocomposite resin material obtained by curing the nanocomposite resin composition according to claim 1.
